(19) United States
(12) Patent Application Publication
(10) Pub. No.: US 2015/0082429 A1
(43) Pub. Date: Mar. 19, 2015

(54) PROTECTING WIRELESS NETWORK FROM ROGUE ACCESS POINTS

(71) Applicant: CISCO TECHNOLOGY, INC., San Jose, CA (US)

(72) Inventors: Hari Rangarajan, San Jose, CA (US); Julan Hsu, San Jose, CA (US); Tak Ming Pang, Palo Alto, CA (US)

(73) Assignee: CISCO TECHNOLOGY, INC., San Jose, CA (US)

(21) Appl. No.: 14/029,624

(22) Filed: Sep. 17, 2013

(51) Int. Cl. H04L 29/06

(52) U.S. Cl. CPC H04L 63/08
USPC 726/23

(57) ABSTRACT

In one embodiment, a method includes receiving at an access point, notification of a rogue device in a wireless network, transmitting a plurality of association requests to the rogue device from the access point, and for each of the association requests that is accepted, transmitting a message to maintain an association between the access point and the rogue device to prevent association of clients with the rogue device. An apparatus and logic are also disclosed herein.

### TECHNICAL FIELD

The present disclosure relates generally to wireless networks, and more particularly, to protecting wireless networks from malicious (rogue) access points (APs).

### BACKGROUND

A malicious party may masquerade as a legitimate wireless local area network (WLAN) in an attempt to attack unsuspecting clients. For example, a rogue AP may attempt a man-in-the-middle attack to clients that may associate with the malicious AP's WLANs. The rogue AP may even broadcast the same SSIDs (service set identifiers) as the legitimate APs. An unauthorized wireless network presents a number of security concerns.

### BRIEF DESCRIPTION OF THE DRAWINGS

FIG. 1 illustrates an example of a network in which embodiments described herein may be implemented.

FIG. 2 depicts an example of a network device useful in implementing embodiments described herein.

FIG. 3 is a flowchart illustrating a process for quarantining a rogue AP, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises receiving at an access point, notification of a rogue device in a wireless network, transmitting a plurality of association requests to the rogue device from the access point, and for each of said association requests that is accepted, transmitting a message to maintain an association between the access point and the rogue device to prevent association of clients with the rogue device.

In another embodiment, an apparatus generally comprises a processor for receiving notification of a rogue device in a wireless network, transmitting association requests to the rogue device, and for each of said association requests that is accepted, transmitting a message to maintain an association between the apparatus and the rogue device to prevent association of clients with the rogue device. The apparatus further comprises memory for storing information about the rogue device.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

Wireless local area networks (WLANs) typically include an access point (AP) and one or more client devices (also referred to as clients or stations). Any device that shares a radio spectrum with a secure network and is not managed or controlled by the owner of the secure network may be considered a rogue device. For example, an access point that has been installed on a secure network without explicit authorization from a local network administrator or created to conduct a man-in-the-middle attack may be considered a rogue access point.

The embodiments described herein provide a pro-active approach to quarantine rogue access points by exploiting the need of a wireless access point to maintain a client table. As described in detail below, one embodiment renders the access point incapable of servicing end-user clients through the use of a coordinated distributed denial of (client) service attack on the malicious AP by associating enough virtual clients simulated by neighboring APs to overload the malicious AP's client (memory) tables.

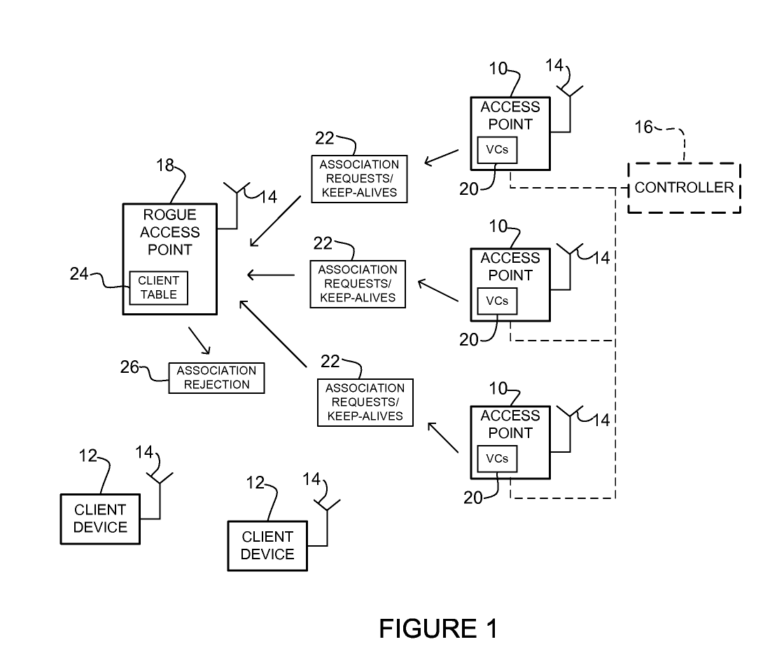

Referring now to the drawings, and first to FIG. 1, an example of a network in which embodiments described herein may be implemented is shown. For simplification, only a small number of network devices are shown. The network shown in FIG. 1 includes three access points (APs) 10 and two client devices (stations) 12. The client device 12 may be, for example, a personal computer, laptop, mobile device (e.g., phone, tablet, personal digital assistant), or any other wireless device. The AP 10 is also in communication with a wired network or wireless network (not shown) for communication with other networks. Each AP 10 may serve any number of client devices 12. The APs 10 and client devices 12 communicate in a wireless network via antennas 14. The APs 10 and client devices 12 are configured to perform wireless communication according to a wireless network communication protocol such as IEE 802.11, for example.

In one embodiment, the APs 10 are in direct communication with one another (e.g., wireless or wired communication). In another embodiment, the APs are all in communication with a common (central) controller 16 operable to control operation of the APs 10. The controller 16 may be located at one of the APs 10 or at a separate network device. It is to be understood that the term ‘access point’ as used herein may refer to any network device operable to transmit association requests in a wireless network.

In the example shown in FIG. 1, a rogue AP 18 is located in the same radio spectrum as the APs 10 and clients 12. As described in detail below, each legitimate AP 10 is operable to generate (simulate) any number of virtual clients 20 that are used to transmit service requests (association requests) 22 to the rogue AP 18 to overload a client table 24 at the rogue AP. Once the client table 24 is full, the rogue AP 18 will no longer be able to take on new clients 12 and will signal this via client association rejections 26. The client table 24 may be any data structure configured to store a list of devices associated with the access point 18.

In one embodiment, the client table 24 is flooded to the maximum limit by creating virtual (dummy) clients 20 that associate to the malicious AP 18. This can be launched as a WLAN deployment wide attack initiated by the master (central) controller 16, for example. The controller 16 coordinates the deployed APs 10 to flood the rogue AP 18 client table 24. For example, the controller 16 may instruct the set of APs 10 that are in the RF neighborhood of the rogue AP 18 to simulate virtual clients 20 and associate to the rogue AP. When the rogue AP 18 is no longer able to take on new clients, it will signal this via client association rejections 26. The controller 16 can stop at this point, after understanding the limit of the client table 24, or engage in constantly creating new clients 20 and probing the rogue AP 18. In order to continue being associated, virtual clients 20 preferably send keep-alive messages (e.g., IEEE 802.11 null data packets) periodically (e.g., on the order of tens of seconds) to stay associated with the rogue AP 18.

Various methods may be used to detect the rogue AP 18, including for example, Rogue Location Detection Protocol (RLDP). In one example, Radio Resource Management (RRM) scanning is used to detect the presence of rogue devices. This may include, for example, off-channel scanning or monitor mode scanning. The rogue AP 18 may be detected by one of the APs 10 used to generate the denial of service attack on the rogue AP or another network device. Information identifying the detected rogue AP 18 is transmitted to the APs 10 from the detecting device, the controller 16, or another AP, for example.

It is to be understood that the network shown in FIG. 1 and described above is only an example and that other networks having different network devices or topologies may be used, without departing from the scope of the embodiments. For example, any number or configuration of APs may be used to generate the denial of service attack on the rogue AP 18. Also, any detection mechanism may be used to identify the rogue AP 18 and notify the APs 10 used in the attack.

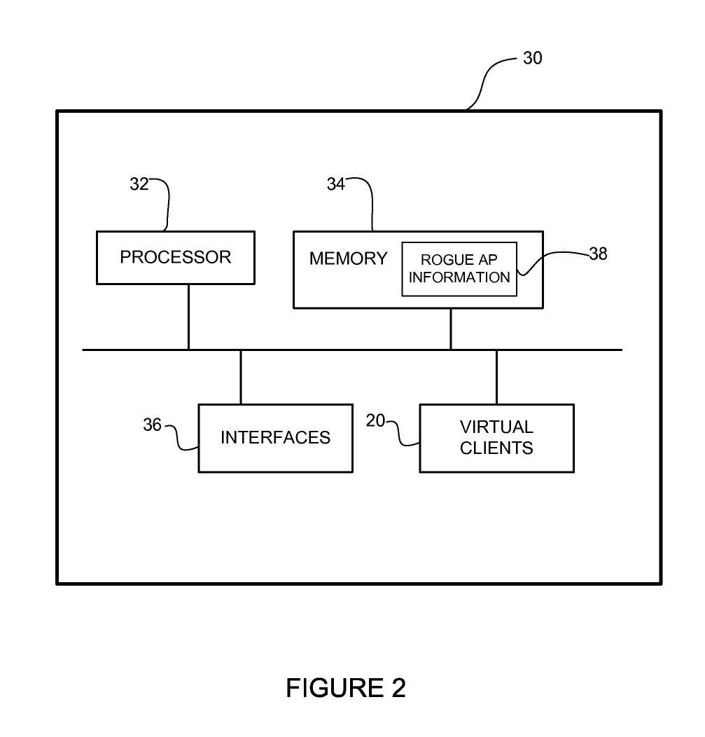

FIG. 2 is a block diagram illustrating an example of a wireless device (e.g., access point) 30 that may be used to implement embodiments described herein. In one embodiment, network device 30 is a programmable machine that may be implemented in hardware, software, or any combination thereof. The network device 30 includes a processor 32, memory 34 and interfaces 36.

Memory 34 may be a volatile memory or non-volatile storage, which stores various applications, modules, and data for execution and use by the processor 32. The memory 34 may include, for example, rogue AP information (e.g., address). The virtual clients 20 may also be stored in memory 34.

Logic may be encoded in one or more tangible computer readable media for execution by the processor 32. For example, the processor 32 may execute codes stored in a computer-readable medium such as memory 34. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium.

The interfaces 36 may comprise any number of interfaces (linecards, ports) for receiving data or transmitting data to other devices. For example, the interfaces may include an Ethernet interface for connection to a computer or network and a wireless interface (e.g., IEEE 802.11 WLAN interface).

It is to be understood that the network device 30 shown in FIG. 2 and described above is only an example and that network devices having different components and configurations may be used without departing from the scope of the embodiments. The network device 30 may further include any suitable combination of hardware, software, algorithms, processors, devices, components, or elements operable to facilitate the capabilities described herein. For example, the network device 30 may include a transceiver, modem, and controller.

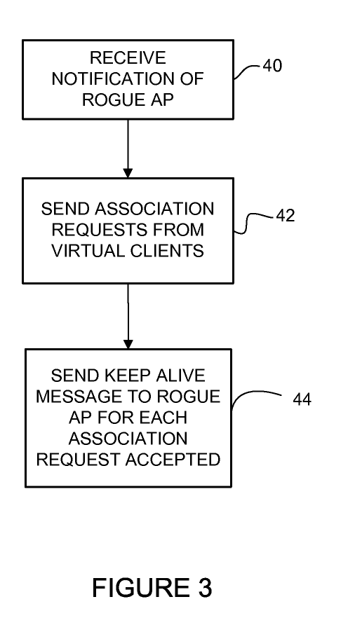

FIG. 3 is a flowchart illustrating a process at the access point 10 for quarantining the rogue AP 18, in accordance with one embodiment. At step 40, the AP 10 receives notification that a rogue AP 18 has been identified. As previously described, any detection method may be used to identify the rogue AP 18. The AP 10 may receive the notification from another AP 10 or the controller 16, for example. The AP 10 sends association requests 22 from virtual clients 20 at the AP (step 42). In one embodiment, neighboring APs 10 also send association requests 22 from virtual clients (FIG. 1). For each of the association requests that is accepted, the AP transmits a keep-alive message to the rogue AP to maintain an association between the AP and the rogue device to prevent association of clients with the rogue device (step 44). When the client table 24 is full, the rogue AP 18 will signal this by rejecting new association requests. Thus, the association rejection may indicate that the client table is full, in which case the controller 16 can stop simulating virtual clients to associate with the rogue AP 18. If the client table 24 is not full at the rogue AP 18 (no association rejection received at the APs 10), the AP 10 continues to send association requests 22.

It is to be understood that the process illustrated in FIG. 3 is only an example and that steps may be modified, added, or combined, without departing from the scope of the embodiments. For example, as described below, there may be a limit as to how many association requests or keep-alive messages 22 are sent to the rogue AP 18, or how many virtual clients 20 send association requests. Also, if any legitimate clients 12 associated to the rogue AP 18 before the AP was quarantined or during the quarantine process, the AP 10 (or other network device) is preferably configured to deauthenticate these clients. This a process in which the AP pretends to be the rogue AP and sends deauthentication messages to the clients of the rogue AP to get the clients to disassociate with the rogue AP.

In one embodiment, the APs 10 (or other network device) detect if the rogue AP 18 has an infinite client table 24. In this case, the AP 10 may be configured to stop sending association requests when a certain threshold is reached (e.g., number of virtual clients 20 sending requests or number of requests 22 sent). In this case, another mechanism, such as the deauthentication process described above, may be used instead of quarantining the rogue AP 18. The deauthentication process may also be used if the rogue AP 18 randomly de-authenticates/disassociates out the virtual clients 20 to make room for new clients.

In one embodiment, the AP 10 uses its reserved MAC (Media Access Control) addresses to pose as clients 20. The AP 10 may also use a random MAC address generator to prevent the rogue AP 18 from black-listing addresses of virtual clients 20. Alternatively, the AP 10 may use a centralized MAC address repository (e.g., addresses reserved for wireless cards and unused). The controller 16 can query the repository, obtain a set of MAC addresses, and distribute the addresses to the APs 10 for use as virtual MAC addresses.

As can be observed from the foregoing, the embodiments provide numerous advantages. For example, one or more embodiments reduce bandwidth and processing requirements by reducing the number of deauthentication requests sent to disassociate a client. The embodiments may be used to render malicious APs ineffective promptly upon detection and prevent clients from associating to rogue APs. A large number of rogue devices can be quarantined due to the low bandwidth requirements. Once the rogue AP is quarantined, the embodiments use very low bandwidth to maintain the rogue AP quarantined, while preventing clients from associating with the rogue AP.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
receiving at an access point, notification of a rogue device in a wireless network;
transmitting a plurality of association requests to the rogue device from the access point; and
for each of said association requests that is accepted, transmitting a message to maintain an association between the access point and the rogue device to prevent association of clients with the rogue device.

2. The method of claim 1 wherein transmitting association requests to the rogue device comprises transmitting association requests from virtual clients installed at the access point and neighboring access points.

3. The method of 2 further comprising identifying a threshold defining a maximum number of virtual clients that can transmit said association requests to the rogue device.

4. The method of claim 1 wherein the access point is in communication with a controller operable to transmit said notification of the rogue device to a plurality of access points.

5. The method of claim 1 wherein said association requests are transmitted from random media access control addresses.

6. The method of claim 1 further comprising receiving a set of media access control addresses from a centralized repository for use as source addresses in said association requests.

7. An apparatus comprising:
a processor for receiving notification of a rogue device in a wireless network, transmitting a plurality of association requests to the rogue device, and for each of said association requests that is accepted, transmitting a message to maintain an association between the apparatus and the rogue device to prevent association of clients with the rogue device; and
memory for storing information about the rogue device.

8. The apparatus of claim 7 wherein said association requests are transmitted from virtual clients installed at the access point and neighboring access points.

9. The apparatus of claim 7 wherein the access point is configured for communication with a controller operable to transmit said notification of the rogue device to a plurality of access points.

10. The apparatus of 9 wherein the controller is operable to identify a threshold defining a maximum number of said association requests that can be transmitted to the rogue device.

11. The apparatus of claim 7 wherein said association requests are transmitted from random media access control addresses.

12. The apparatus of claim 7 wherein the processor is further configured to receive a set of media access control addresses from a centralized repository for use as source addresses in said association requests.

13. The apparatus of claim 7 wherein the processor is further configured to deauthenticate a client associated with the rogue device.

14. The apparatus of claim 7 wherein said message to maintain an association between the apparatus and the rogue device comprises a keep-alive message.

15. Logic encoded on one or more tangible computer readable media for execution and when executed operable to:
receive at an access point, notification of a rogue device in a wireless network;
transmit a plurality of association requests to the rogue device from the access point; and
for each of said requests that is accepted, transmit a message to maintain an association between the access point and the rogue device to prevent association of clients with the rogue device.

16. The logic of claim 15 wherein said association requests are transmitted from virtual clients installed at the access point and neighboring access points.

17. The logic of claim 16 wherein the logic is further operable to identify a threshold defining a maximum number of virtual clients that can transmit said association requests to the rogue device.

18. The logic of claim 15 wherein the access point is configured for communication with a controller operable to transmit said notification of the rogue device to the access point.

19. The logic of claim 15 wherein said association requests are transmitted from random media access control addresses.

20. The logic of claim 15 wherein the logic is further operable to receive a set of media access control addresses from a centralized repository for use as source addresses in said association requests.
